(19) United States
(12) Patent Application Publication
(10) Pub. No.: US 2007/0187380 A1
(43) Pub. Date: Aug. 16, 2007

(54) Welding additive alloy as well as a method for producing a welding wire

(76) Inventor: Jurgen Bruckner, Trautenfels (AT)

Correspondence Address: WILLIAM COLLARD;COLLARD & ROE, P.C., 1077 NORTHERN BOULEVARD, ROSLYN, NY, 11576, US

(21) Appl. No.: 10/592,621

(22) PCT Filed: Feb. 25, 2005
(86) PCT No.: PCT/AT05/00065

§ 371 Date: Sep. 13, 2006

(30) Foreign Application Priority Data
Mar. 24, 2004 (AT) A 520/2004

(51) Int. Cl. B23K 35/34

(52) U.S. Cl. 219/146.22

(57) ABSTRACT

A welding additive alloy, preferably in the form of a welding wire, based on aluminum having the following composition in percent by weight: Si 1-5; Fe<0.1; Mn 0.5-1.5; Zr≦0.01; Cr≦0.01; Cu<0.03; Mg<0.01; Ti<0.005; Na, P, B in sum <0.005; and unavoidable impurities with a portion in percent by weight of <0.001 each, and a balance consisting of Al, as well as a method for producing a welding wire, a method for producing a braze-welded structure, and a braze-welded structure with two component parts (1, 2), wherein one component part (2) consists of aluminum and a second component part (1) consists of steel.

The invention relates to a welding additive alloy, preferably in the form of a welding wire, based on aluminum, as well as to a method for producing a welding wire from a welding additive alloy according to the invention. The invention also relates to a method for producing a braze-welded structure in which two component parts are provided, wherein a first component part consists of aluminum and a second component part consists of steel, and a braze-welded structure with two component parts, wherein one component part consists of aluminum and a second component part consists of steel.

During welding, metallic materials are connected by heating the abutting sites as far as to their melting range by adding a welding additive of the same type and with the same or, as a rule, nearly the same melting range as the materials to be connected. In doing so, however, the production of a welding connection of two metallic materials that have different chemical and physical properties poses a problem. Such great differences with regard to chemical and physical properties occur, e.g., with aluminum and steel because steel has a melting point of 1535° C., whereas aluminium has a melting point of 660° C. Moreover, iron is not soluble in aluminum so that an intermetallic phase (IMP) will occur at the welding connection between aluminum and steel. This intermetallic phase is extremely brittle so that with the help of known welding additives merely welding connections of insufficient strength values can be provided between aluminum and steel. With known welding additives also the corrosion resistance of aluminum/steel welding connections is extremely low.

Welding additive alloys based on aluminum are, e.g., AlSi 5 and Al 99.8 (highly pure aluminum wire), respectively. Besides aluminum, AlSi 5 alloys have the following composition in percent by weight:
Fe 0.6
Cu 0.3
Mg 0.2
Ti 0.15
Si 4.5-6

On the other hand, highly pure aluminum wire, such as Al 99.8, besides aluminum has the following composition in percent by weight:
Fe 0.15
Cu 0.03
Mg 0.02
Ti 0.02

As has already been mentioned before, with these standard wires, however, a pronounced intermetallic phase (IMP) forms when braze welding aluminum and steel so that with these wires, merely braze-welded connections having insufficient (corrosion) strength values can be produced between steel and aluminum.

It is an object of the present invention to provide a welding additive alloy of the initially defined kind, by aid of which two metallic materials having different chemical and physical properties, in particular aluminum and steel, can be connected by a braze-welding method, wherein the braze-welded connection has an increased strength as compared to welding connections with known welding additive alloys. Moreover, the braze-welded connections produced with the welding additive alloy according to the invention shall also have an improved corrosion resistance. Also a method of the initially defined kind for producing a welding wire consisting of an inventive welding additive alloy as well as a method for producing a braze-welded structure and a welded structure of the initially defined kind, which comprise such a welding additive alloy shall be provided.

The welding additive alloy of the initially defined kind is characterized by the following composition in percent by weight:
Si 1-5
Fe<0.1
Mn 0.5-1.5
Zr≦0.01
Cr≦0.01
Cu<0.03
Mg<0.01
Ti<0.005
Na, P, B in sum <0.005
   and unavoidable impurities with a portion in percent by weight of ≦0.001 each and a balance consisting of Al.

The composition of the aforementioned welding additive alloy is particularly characterized by the presence of the said minimum portions of silicon and manganese. Furthermore, as compared to known welding additive alloys, comparatively low portions of the remaining components (in particular of Fe, Mg) are provided so that—apart from the silicon and manganese portions—an extremely pure aluminum alloy is present. Tests have shown that by this a very good connection of two different metallic materials, in particular aluminum and steel, is achieved. Especially the formation of the intermetallic phase (IMP) as forms due to the insolubility of iron in aluminum, is comparatively slight as compared to braze-welded connections using known welding additives. Moreover, also a good corrosion resistance has been achieved in tests using the welding additive alloy according to the invention.

If the limiting values of the silicon portion of the welding additive alloy according to the invention are fallen below or exceeded, a tongue-shaped growth of the intermetallic phase (IMP) will occur, resulting in a marked deterioration of the mechanical properties of the welding connection.

Also the manganese portion according to the invention serves to keep relatively slight the formation of the intermetallic phase (IMP) between the two materials to be connected. In addition, the manganese portion also serves to reduce the tendency to an intercrystalline corrosion of the welding additive.

Tests have shown that the formation of the intermetallic phase between two metallic materials, particularly in case of aluminum and steel, is especially slight if the Si content is between 2-3.5, preferably substantially 3.

Likewise, in tests the best strength values could be achieved, particularly with regard to the corrosion resistance of a braze-welded connection, if the Mn content is between 0.9-1.1, preferably substantially 1.

It is also possible to further add microelements for improving the fineness of grain and/or the ductility of the texture of the welding wire composition. For this purpose, the elements Zr, Na, Li, Be, P, Ka, Ca, Sr and/or Sb could, e.g. be admixed, which means that the elements could be admixed to the welding additive alloy according to the invention either individually or in combination.

The method for producing a welding wire of the initially defined kind is characterized in that a body having the following composition in percent by weight is provided:

Si 1-5

Fe<0.1

Mn 0.5-1.5

Zr≦0.01

Cr≦0.01

Cu<0.03

Mg<0.01

Ti<0.005

Na, P, B in sum <0.005

and unavoidable impurities with a portion in percent by weight of <0.001 each, and a balance consisting of Al, and that a body consisting of this alloy is drawn for producing a welding wire.

Basically, all the advantages for a welding wire produced according to the method of the invention already result from the advantages mentioned before in connection with the inventive welding additive alloy, so that reference is made to what has previously been said in order to avoid repetitions.

The method according to the invention for producing a braze-welded structure of the initially defined kind is characterized in that the two component parts are braze-welded by aid of a welding additive which comprises a welding additive alloy according to any one of claims 1 to 3. By welding together the aluminum component part with the steel component part with the help of a welding additive comprising the inventive alloy, improved strength values, in particular also improved corrosion resistance values, as compared to the known welding additives can be achieved, as has already been discussed before.

The braze-welded structure of the initially defined kind is characterized in that the two component parts are braze-welded with the help of a welding additive which comprises a welding additive alloy according to any one of claims 1 to 3. Thus, for the first time a braze-welded structure is created from an aluminum component portion and a steel component portion whose braze-welded connection has a high strength and also a high corrosion resistance. Also here, further advantages result form what has already previously been said.

The invention will be described in more detail hereinafter by way of a preferred exemplary embodiment illustrated in the drawing, to which embodiment, however, it shall not be restricted. In detail, in the drawing,

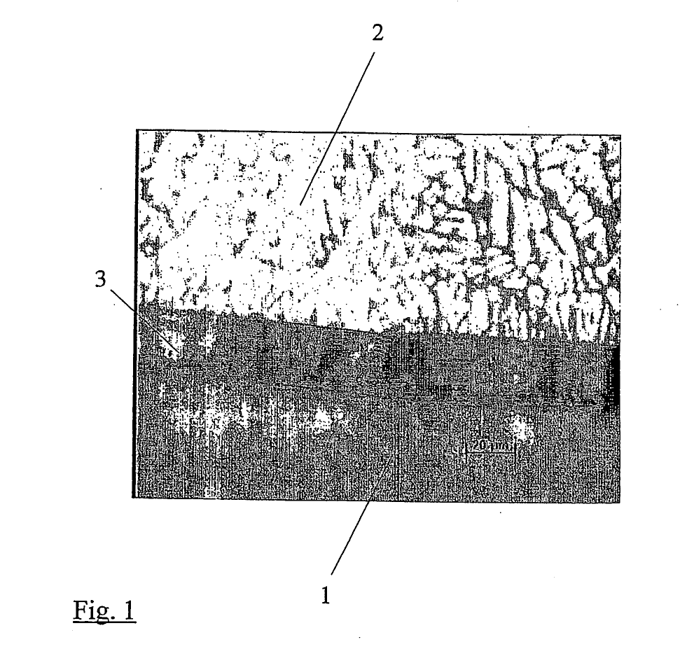

FIG. 1 shows a photographic image of a section through a welding connection between a steel and an aluminum material according to the prior art, wherein an Al 99.5 standard welding wire has been used as welding additive; and

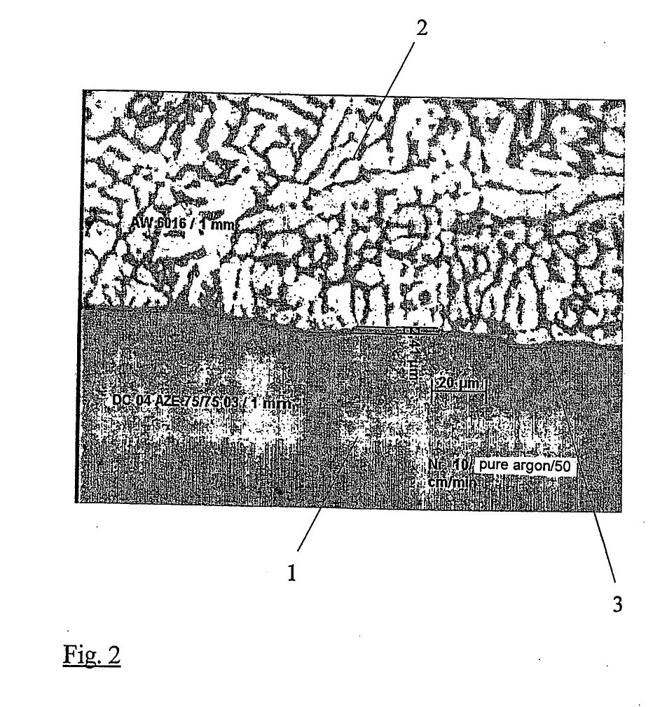

FIG. 2 shows a photographic image of a section through a braze-welded connection between a steel and an aluminum material, wherein a welding wire having the welding additive alloy according to the invention was used when making a braze-welded connection.

In FIG. 1, a welding connection between a steel sheet (CD 04 AZE) 1 having a sheet thickness of 1 mm, and an aluminum sheet (AW 6016) 2 also having a sheet thickness of 1 mm is shown. When making the braze-welded connection, a highly pure aluminum standard welding wire (Al 99.5) was used. Here it is visible that during welding a distinct development of the intermetallic phase 3 having a thickness of 10 μm occurs. Since such a marked intermetallic phase 3 constitutes a brittle connection between the steel material 1 and the aluminum material 2, such braze-welded connections have insufficient strength values.

In FIG. 2, also a braze-welded connection between a steel sheet (DC 04 AZE) 1 having a wall thickness of 1 mm and an aluminum sheet (AW 6016) 2, also having a wall thickness of 1 mm, is shown, wherein a welding wire having the alloy according to the invention was used instead of the standard welding wire Al 99.5 (cf. FIG. 1).

As can be seen from FIG. 2, here the formation of the intermetallic phase 3 is substantially slighter and, in the section illustrated, merely has a thickness of 2.41 μm. Thus, by reducing the intermetallic phase 3 between the two metallic materials 1, 2, a braze-welded connection could be achieved between an aluminum and a steel material, which braze-welded connection has substantially higher strength values, in particular also higher corrosion resistance values, as compared to known welding wires.

In order to test the corrosion resistance of the braze-welded connection between the steel sheet 1 and the aluminum sheet 2, a so-called salt spray test according to DIN 50021/S was carried out, in which the samples were sprayed with a sodium chloride-containing mist for 120 hours. In this way, the humidifying of samples, as it occurs e.g. in the wintertime after the application of de-icing salts on roads with heavy traffic, or along the seashore, was simulated.

As can be seen from the following Table 1, in tests with an AlSi 5 (AW 4043) standard welding wire, satisfactory static strength values could be achieved, yet this standard welding wire has a lower portion of manganese as compared to a welding wire according to the invention, so that such a braze-welded connection has an insufficient corrosion resistance.

TABLE 1

| | Rₘ [N/mm²] | Rₘ [N/mm²] |
|---|---|---|
| Welding Wire | without corrosion | with corrosion |
| AW 4043 | 148 | 83 |
| according to invention | 165 | 161 |

Summing up, it is thus shown that by the welding additive alloy of the invention it has become possible for the first time to produce a braze-welded connection of different metallic materials, such as aluminum and steel, which has both satisfactory strength values and satisfactory corrosion resistance.

1-6. (canceled)

7. The use of an alloy based on aluminum, comprising the following composition in percent by weight:
Si 1-5
Fe<0.1
Mn 0.5-1.5
Zr£0.01
Cr£0.01
Cu<0.03
Mg<0.01
Ti<0.005
Na, P, B in sum <0.005
and unavoidable impurities with a portion in percent by weight of <0.001 each, and a balance consisting of Al as a welding additive alloy, preferably in the form of a welding wire, for welding together aluminum and steel.

8. The use according to claim 7, wherein the Si content of the alloy is between 2-3.5, preferably substantially 3.

9. The use according to claim 7, wherein the Mn content of the alloy is between 0.9-1.1, preferably substantially 1.

10. A method for producing a welding wire from a welding additive alloy based on aluminum for welding together aluminum and steel, wherein a body having the following composition in percent by weight is provided:
Si 1-5
Fe<0.1
Mn 0.5-1.5
Zr£0.01
Cr£0.01
Cu<0.03
Mg<0.01
Ti<0.005
Na, P, B in sum <0.005
and unavoidable impurities with a portion in percent by weight of <0.001 each, and a balance consisting of Al, and a body consisting of this alloy is drawn for producing a welding wire.

11. A method for producing a braze-welded structure, in which two component parts (1, 2) are provided, wherein a first component part (2) consists of aluminum and a second component part (1) consists of steel, wherein the two component parts (1, 2) are braze-welded by aid of a welding additive which comprises a metal alloy according to claim 7.

12. A braze-welded structure with two component parts (1, 2), wherein one component part (2) consists of aluminum and a second component part (1) consists of steel, wherein the two component parts (1, 2) are braze-welded by aid of a welding additive which comprises a metal alloy according to claim 7.
